(19) United States
(12) Patent Application Publication
(10) Pub. No.: US 2001/0009542 A1
(43) Pub. Date: Jul. 26, 2001

(54) Credit card-type data medium adapted for CD-ROM player or the like

(76) Inventor: Laurent Benedetti, Chateauroux (FR)

Correspondence Address: James C. Lydon, Suite 100, 100 Daingerfield Road, Alexandria, VA, 22314, US

(21) Appl. No.: 09/770,649

(22) Filed: Jan. 29, 2001

Related U.S. Application Data
(63) Continuation of application No. PCT/FR99/01867, filed on Jul. 28, 1999.

(30) Foreign Application Priority Data
Jul. 29, 1998 (FR) 98/09910

(51) Int. Cl. G11B 3/70; G11B 5/84; G11B 7/26

(52) U.S. Cl. 369/280; 369/272

(57) ABSTRACT

A data medium whereon are recorded data readable in a CD-ROM player which includes a support for receiving CD-ROM discs with a diameter of 12 cm and a recessed site for discs of 8 cm. The data medium has the format of a credit card and includes positioning or centering means for the player to be able to read in the same way as a CD-ROM disc. The positioning and centering means include two projecting portions such as stripes or a single-piece arc-shaped part designed to be urged into contact with the inner circular rim of the hollow site for the discs with a diameter of 8 cm.

### TECHNICAL FIELD

The present invention relates to data media of CD-ROM type on which data used by a computer can be recorded, and particularly to a credit card-type data medium adapted for a CD-ROM player or the like.

### BACKGROUND ART

Attempts have already been made to use credit card-type data media for recording data which can be read by a computer. The data is recorded on circular tracks as on a floppy disc. In order for these media to be read by drives adapted to read floppy discs, the card must obviously be equipped with centering means so that the card may be rotated in the same manner as a floppy disc, as described in document FR.2.668.277.

Attempts have also been made to use credit card-format cards as a CD-ROM. In this manner, one side of the card features circular tracks which can be read by a CD-ROM player and the other side may feature information which can be read by a user.

There are two types of CD-ROM players. In the first type of player, the disc, which has a circular hole in the center, is positioned in the player by means of a rotating central pivot in the player onto which the disc is clipped. In the second type of player, however, the disc is simply placed in the circular-shaped site corresponding to the size of the disc. The player thus features two concentric circular locations, one location of 12 cm in diameter for discs measuring 12 cm in diameter and an 8 cm diameter location for discs measuring 8 cm in diameter.

As a result, a credit-card type data medium is entirely contained in the 12 cm diameter location, although it is longer than the 8 cm location. Card positioning and centering means must thus be provided in relation to the 8 cm location, such positioning means being reliable enough to ensure simple and permanent centering of the data medium.

### DISCLOSURE OF THE INVENTION

This is why the purpose of the invention is to provide a data medium which is preferably of credit card format, featuring positioning and centering means that allow it to be easily inserted in a CD-ROM player or the like and recorded data to be read with a high degree of reliability.

The object of the invention is therefore a data medium on which data that can be read in a CD-ROM player or the like is recorded, including a support designed to receive CD-ROM discs or the like and having a recessed location for the discs measuring 12 cm in diameter and a recessed location for discs measuring 8 cm in diameter. The data medium according to the invention is preferably of credit card format and features positioning or centering means allowing it to be read by the player in the same manner as a disc. The positioning and centering means are comprised of arc-shaped projecting portions designed to come into optimal contact with the interior circular edge of one of the recessed locations, particularly the recessed location for 8 cm diameter discs.

### BRIEF DESCRIPTION OF THE DRAWINGS

The purposes, objects and characteristics of the invention will become more apparent from the following description when taken in conjunction with the accompanying drawings in which:

FIG. 1 shows the disc support of a CD-ROM player showing the locations for the 12 cm and 8 cm CD-ROM discs which can be read by the player as well as a credit card-type data medium according to the invention ready to be read,

FIG. 2 shows a data medium of credit card type according to a first embodiment of the invention, adapted to be read by the CD-ROM player shown in FIG. 1,

FIG. 3 represents an enlargement of a portion of the positioning and centering means of the data medium shown in FIG. 2,

FIG. 4 represents a data medium of credit card type according to a second embodiment of the invention, adapted to be read by the CD-ROM player shown in FIG. 1,

FIG. 5 represents an enlargement of a portion of the positioning and centering means of the data medium shown in FIG. 4,

FIG. 6 represents the back of a credit card according to the invention featuring a magnetic stripe, and

FIG. 7 represents the back of a credit card according to the invention featuring a chip.

### DETAILED DESCRIPTION OF THE INVENTION

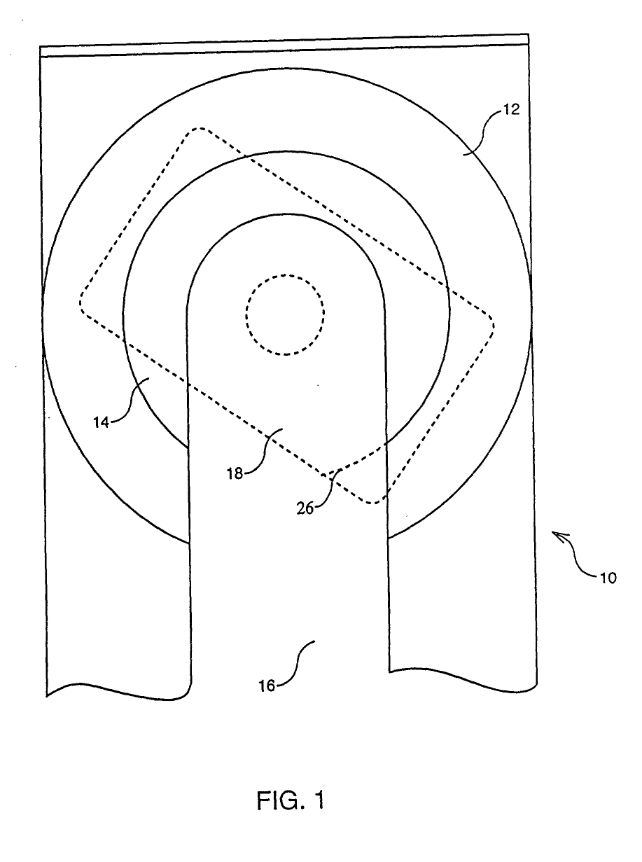

CD-ROM players are often in the form as represented in FIG. 1. If there is no central pivot to drive the disc, as in players installed in laptop computers, the part of the player or support 10 designed to receive the CD-ROM inserted by the user features 2 slightly recessed circular locations. The first location 12 is defined by a circular arc of 12 cm in diameter and is designed to receive CD-ROM discs measuring 12 cm in diameter. The second location 14, which is slightly recessed in relation to the first location 12, is defined by a circular arc 8 cm in diameter in order to receive CD-ROM discs measuring 8 cm in diameter. Furthermore, the support 10 features a recess 16 so that the player's mechanism (not shown) can grasp, lift and rotate the disc so that the recorded data can be read.

As shown in FIG. 1, a data medium 18, having the format of a credit card measuring approximately 8.5 cm by 5.5 cm, is shorter in length than the diameter of the first location 12, although larger in diameter than the second location 14. The positioning and centering of such a card could thus take place owing to the projecting portions of the card which are retained by the rim of the slightly recessed second location 14.

It was believed that such means had to be as small as possible so that they will be hardly noticeable on the card. For example, they may have taken the form of a few nibs located at the limit of the 8 cm diameter in relation to the center of the card. In this manner, one could imagine that only 4 properly placed nibs would be needed to retain the card using the edge of the recessed location 14. Unfortunately, it turns out that the presence of simple nibs is not enough to ensure card positioning and centering.

Firstly, after the card is placed on the support 10 and inserted into the computer, a slight, unavoidable jolt occurs and the nibs are not sufficient to securely maintain the card which is rapidly moved off center.

Next, owing to the recess 16, one of the nibs may not be touching the support when the disc is installed and which may cause the card to be unstable and enhance the inconvenience mentioned above. Even if the card was correctly positioned initially, the player mechanism then places the card randomly with the same risk of becoming unstable because one of the nibs is not supported, during a second reading of the card.

Finally, there are players in which the support 10 is slightly inclined (at an angle of approximately 10°). It turns out that a few nibs are not sufficient to prevent the card from sliding on the support, primarily when the player is closed.

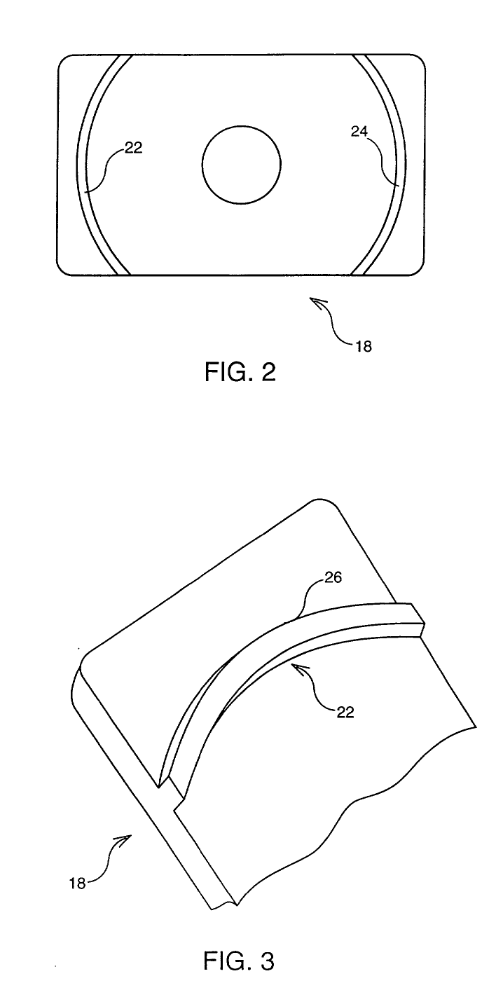

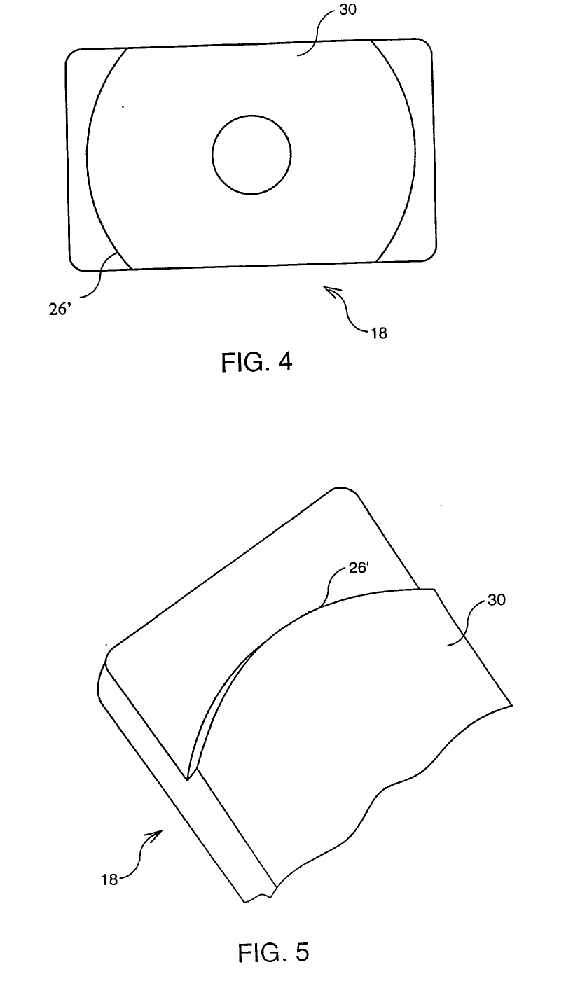

This is why, according to a first embodiment of the invention represented in FIG. 2, the data medium features two arc-shaped ribs 22 and 24 from one side to the other of the card 18, at each end of the card, having a rectangular cross-section and the two walls of which are perpendicular to the surface of the card. Each rib, shown enlarged in FIG. 3, is preferably between 0.2 mm and 0.5 mm thick and between 0.2 mm and 1 mm wide. The exterior circular edge 26 has a diameter equal to or slightly less than 8 cm so that it positions exactly inside the second recessed location 14 of the support 10 of the reader.

It should be noted that the essential feature of the invention is that each rib 22 (or 24) has optimum contact along the entire edge of the location 14. One can thus imagine a shape other than circular arcs while maintaining the same general appearance. The rib may be slightly chamfered at least on its outer edge 26 so that the card is automatically positioned when it is placed on the support, and centered approximately.

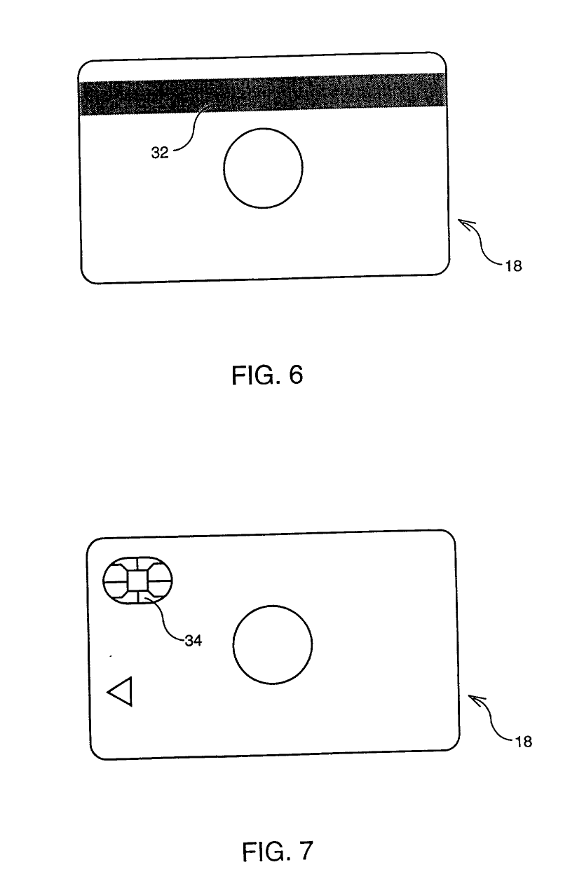

The positioning of the exterior circular edge 26 or 26′ in the location 14 is clearly visible in FIG. 1. It should be noted that the part of the card's exterior edge in contact with the edge of the location 14 is still significant even if the data medium 18 is placed crosswise in the player, as shown in FIG. 1. As illustrated in FIG. 6, the card 18 may feature a magnetic stripe 32 on the reverse side. A CD-ROM card of this type, featuring software stored on the readable part in the support 10, may thus provide secure capabilities when payments or access are made with the card, owing to the magnetic stripe which enables the cardholder to be authenticated. It should be noted that the card could also incorporate a chip 34, or even a chip with a magnetic stripe as shown in FIG. 7 for the same reasons as mentioned above.

Although the preferable format of the data media according to the invention is that of a standard credit card, it stands to reason that such a support may have any other format although, however, different from a disc measuring 8 to 12 cm in diameter, so that the projecting part according to the invention is required for it to be correctly positioned in the location for the 8 cm diameter disc or in the location for the 12 cm diameter disc. A rectangular shaped support could also be provided having the format of a business card measuring 8.2 cm by 12.5 cm and the projecting part of which, in this case, is adapted to be positioned in the location reserved for 12 cm diameter discs.

Finally, although the invention was described with reference to CD-ROM type media, it is clear that it could be applied to all equivalent or derivative technologies such as CD audio, CD-R, CD-RW, and DVD, etc. which call for or will call for players of the same type.

1. A data medium on which data that can be read in a CD-ROM player or the like is recorded, including a support (10) designed to receive the CD-ROM discs and having a recessed location (12) for discs measuring 12 cm in diameter and a recessed location (14) for discs measuring 8 cm in diameter, said data medium featuring positioning or centering means so that it can be read by the player in the same manner as a disc;
said data medium being characterized in that said positioning and centering means are comprised of projecting portions (22, 24, 30), the exterior edge (26, 26′) of which is generally in the shape of a circular arc designed to come into optimal contact with the interior circular edge of one of said recessed locations.

2. The data medium according to claim 1, having the format of a standard credit card and said projecting portions (22, 24, 30) of which are designed to come into contact with the interior circular edge of said recessed location for discs measuring 8 cm in diameter.

3. The data medium according to claim 2, wherein said projecting portions (22, 24, 30) extend between the two edges of the card, the exterior edge (26, 26′) of said projecting portions having a diameter of 8 cm so that said projecting portions are in contact with the interior edge of said location (14) over their entire length for discs measuring 8 cm in diameter.

4. The data medium according to claim 3, wherein said projecting portions (22, 24, 30) have a slightly beveled exterior edge (26, 26′) in relation to the surface of said data medium.

5. The data medium according to any of claims 2, 3 or 4 wherein said projecting portions consist of two ribs (22, 24) forming a circular arc.

6. The data medium according to claim 5, wherein said ribs (22, 24) have a rectangular cross-section, the walls being perpendicular to the surface of the data medium.

7. The data medium according to claim 6, wherein said ribs (22, 24) have a width ranging from 0.2 mm to 1 mm.

8. The data medium according to any one of claims 5, 6 or 7, wherein said ribs (22, 24) have a thickness ranging from 0.2 mm to 0.5 mm.

9. The data medium according to any one of claims 2, 3 or 4 wherein said projecting portions consist of a portion (30) of said card which protrudes in relation to the rest of said card and limited by two circular arcs, the exterior edge (26′) of which is designed to come into optimal contact with the interior circular edge of said recessed location for discs measuring 8 cm in diameter.

10. The data medium according to claim 9, wherein said projecting portion (30) of said card features an exterior edge (26′) which is slightly chamfered in relation to the surface of said card.

11. The data medium according to claim 8, 9 or 10 wherein the thickness of said projecting portion (30) ranges from 0.2 mm to 0.5 mm.

12. The data medium according to any one of the previous claims featuring a magnetic stripe (32) and/or a chip (34) on its reverse side.
